(19) United States
(12) Patent Application Publication
(10) Pub. No.: US 2012/0063557 A1
(43) Pub. Date: Mar. 15, 2012

(54) Phase adjustment circuit, receiving apparatus and communication system

(75) Inventors: Tomokazu Tanaka, Kanagawa (JP); Hideo Morohashi, Kanagawa (JP); Hiroshi Iizuka, Kanagawa (JP)

(73) Assignee: Sony Corporation, Tokyo (JP)

(21) Appl. No.: 13/137,018

(22) Filed: Jul. 15, 2011

(30) Foreign Application Priority Data
Sep. 15, 2010 (JP) 2010-206741

(51) Int. Cl. H04L 7/00

(52) U.S. Cl. 375/371

(57) ABSTRACT

A phase adjustment circuit includes: a serial-to-parallel conversion section configured to convert serial data including a synchronization pattern inserted into a predetermined position into parallel data in response to a clock; a synchronization-pattern-position detection section configured to detect the position of the synchronization pattern in the parallel data generated by the serial-to-parallel conversion section; and an adjustment section configured to adjust the phases of the parallel data and the clock to conform to a position detected by the synchronization-pattern-position detection section as the position of the synchronization pattern in accordance with information on the position of the synchronization pattern.

### BACKGROUND

The present disclosure relates to a phase adjustment circuit applied to serial communications which used for receiving typically digital signals, a receiving apparatus employing the phase adjustment circuit and a communication system employing the receiving apparatus.

In recent years, the serial transmission system is adopted in order to broaden the data bandwidth and a system with much fewer signal lines is introduced.

In addition, in order to meet a demand for doubling or quadrupling of the data bandwidth, there has been adopted a method for implementing one serial transmission system in the form of a plurality of parallel channels.

In the case of such a method, it is necessary to reduce data and clock skews between the channels due to restrictions imposed on a system provided at a later stage.

If the same clock is used for the channels, synchronization between the channels can be established.

In addition, by inserting a synchronization pattern such as a comma pattern into a predetermined position in serial data transmitted from the data transmitting side and detecting the comma pattern used as a synchronization pattern on the receiving side, synchronization can be assured.

FIG. 1 is a block diagram showing the configuration of a phase switching circuit 1 for detecting a synchronization pattern in order to switch the phase of a clock. For more information on this phase switching circuit 1, the reader is advised to refer to Japanese Patent Laid-open No. Hei 11-186996 (hereinafter referred to as Patent Document 1).

As shown in the figure, the phase switching circuit 1 has a variable-delay circuit 2, a synchronization circuit 3 and a data hold section 4.

In the phase switching circuit 1, input serial data DT1 is delayed by the variable-delay circuit 2 by a predetermined delay time and is output as internal data DT2. The variable-delay circuit 2 employs a phase-switching processing section 2a.

The input serial data DT1 is also supplied to the synchronization circuit 3. The synchronization circuit 3 detects a specific-signal position in the input serial data DT1 and supplies a signal for the specific-signal position to the data hold section 4 as an input data position signal P.

The data hold section 4 temporarily holds the input data position signal P.

The input data position signal P held in the data hold section 4 is fetched in accordance with an internal timing signal S1 and supplied to the phase-switching processing section 2a as a delay quantity DL.

It is to be noted that an internal clock ICK is supplied to the phase-switching processing section 2a, the synchronization circuit 3 and the data hold section 4.

With the serial data sustained in the serial form as it is, the phase switching circuit 1 having the configuration described above detects the synchronization pattern used as a comma pattern and switches the phase of the clock in accordance with the result of the detection.

### SUMMARY

By the way, as described above, if the same clock is used for a plurality of channels, synchronization between the channels can be established. If each of the channels is implemented by an independent IC, however, it is necessary to carry out processing to link the ICs to each other by making use of the same clock.

It is needless to say, nevertheless, that each of the ICs has a number of pins, making the configuration of the circuit complicated. In addition, the occupied area and the power consumption increases.

On top of that, as described above, with the serial data sustained in the serial form as it is, the phase switching circuit 1 disclosed in Patent Document 1 detects the comma-pattern position and switches the phase of the clock in accordance the result of the detection. Thus, even if each of the channels is implemented by an independent IC, synchronization between the channels can be established.

In accordance with this technology, however, a synchronization circuit section needs to include such as a high-speed counter so that implementation in the high-speed serial communication having a communication speed in the giga order is difficult.

It is thus desirable to provide a phase adjustment circuit which can establish synchronization among a plurality of channels while preventing the circuit configuration from increasing complexity and preventing the power consumption from increasing, and can be applied to high-speed serial communications. In addition, it is also desirable to provide a receiving apparatus employing the phase adjustment circuit and a communication system employing the receiving apparatus.

A phase adjustment circuit according to a first mode of the present disclosure includes:

a serial-to-parallel conversion section configured to convert serial data including a synchronization pattern inserted into a predetermined position into parallel data in response to a clock;

a synchronization-pattern-position detection section configured to detect the position of the synchronization pattern in the parallel data generated by the serial-to-parallel conversion section; and

an adjustment section configured to adjust the phases of the parallel data and the clock to conform to a position detected by the synchronization-pattern-position detection section as the position of the synchronization pattern in accordance with information on the position of the synchronization pattern.

A receiving apparatus according to a second mode of the present disclosure includes a phase adjustment circuit configured to carry out functions to:

receive serial data propagating through a data transmission line and including a synchronization pattern inserted into a predetermined position;

convert the serial data into parallel data; and

adjust the phases of the parallel data and a clock in accordance with information on a position acquired from the parallel data as the position of the synchronization pattern.

To put it concretely, the phase adjustment circuit includes:

a serial-to-parallel conversion section configured to convert the serial data including a synchronization pattern inserted into a predetermined position into the parallel data in response to the clock;

a synchronization-pattern-position detection section configured to detect the position of the synchronization pattern in the parallel data generated by the serial-to-parallel conversion section; and

an adjustment section configured to adjust the phases of the parallel data and the clock to conform to a position detected by the synchronization-pattern-position detection section as the position of the synchronization pattern in accordance with information on the position of the synchronization pattern.

A communication system according to a third mode of the present disclosure includes:

a transmitting apparatus configured to transmit serial data including a synchronization pattern inserted into a predetermined position through a data transmission line; and

a receiving apparatus configured to receive the serial data propagating through the data transmission line and including a synchronization pattern inserted into a predetermined position.

The receiving apparatus has a phase adjustment circuit for:

converting the serial data received thereby into parallel data; and

adjusting the phases of the parallel data and a clock in accordance with information on a position acquired from the parallel data as the position of the synchronization pattern.

To put it concretely, the phase adjustment circuit includes:

a serial-to-parallel conversion section configured to convert the serial data including a synchronization pattern inserted into a predetermined position into the parallel data in response to the clock;

a synchronization-pattern-position detection section configured to detect the position of the synchronization pattern in the parallel data generated by the serial-to-parallel conversion section; and

an adjustment section configured to adjust the phases of the parallel data and the clock to conform to a position detected by the synchronization-pattern-position detection section as the position of the synchronization pattern in accordance with information on the position of the synchronization pattern.

In accordance with the present disclosure, it is possible to provide a phase adjustment circuit which can establish synchronization among a plurality of channels while preventing the circuit configuration from increasing complexity and preventing the power consumption from increasing, and can be applied to high-speed serial communications. In addition, it is also possible to provide a receiving apparatus employing the phase adjustment circuit and a communication system employing the receiving apparatus.

### BRIEF DESCRIPTION OF THE DRAWINGS

FIG. 1 is a block diagram showing the configuration of a phase switching circuit for detecting a synchronization pattern in order to switch the phase of a clock;

FIG. 2 is a block diagram showing the basic configuration of a communication system according to an embodiment of the present disclosure;

FIG. 3 is a block diagram showing the configuration of a phase adjustment circuit employed in a receiving apparatus included in the communication system in accordance with the embodiment of the present disclosure;

FIG. 4 is a block diagram showing a typical configuration of a skew generator employed in the phase adjustment circuit according to the embodiment of the present disclosure;

FIG. 5 is an explanatory diagram to be referred to in description of a principle to detect information on the phase of a clock by making use of information on the position of a comma pattern serving as a synchronization pattern as a diagram showing the configuration of a 1:2 serial-to-parallel conversion circuit;

FIGS. 6A and 6B are explanatory diagrams to be referred to in description of the phase of a second clock for confirming data output by the 1:2 serial-to-parallel conversion circuit shown in FIG. 5;

FIG. 7 is a circuit diagram showing the configuration of a 1:N serial-to-parallel conversion circuit;

FIG. 8 is a diagram showing leading and lagging relations between the phases of N pieces of parallel data output by the 1:N serial-to-parallel conversion circuit shown in FIG. 7 and the phase of a clock;

(A) to (C) of FIG. 9 are diagrams showing typical timings for a case in which 12-phase clocks are used in the 1:N serial-to-parallel conversion circuit shown in FIG. 7 where N=36;

FIG. 10 is a circuit diagram showing a typical configuration of a multi-phase clock generator according to the embodiment; and

FIG. 11 is a diagram showing relation of timings for N=6 in the multi-phase clock generator shown in FIG. 10.

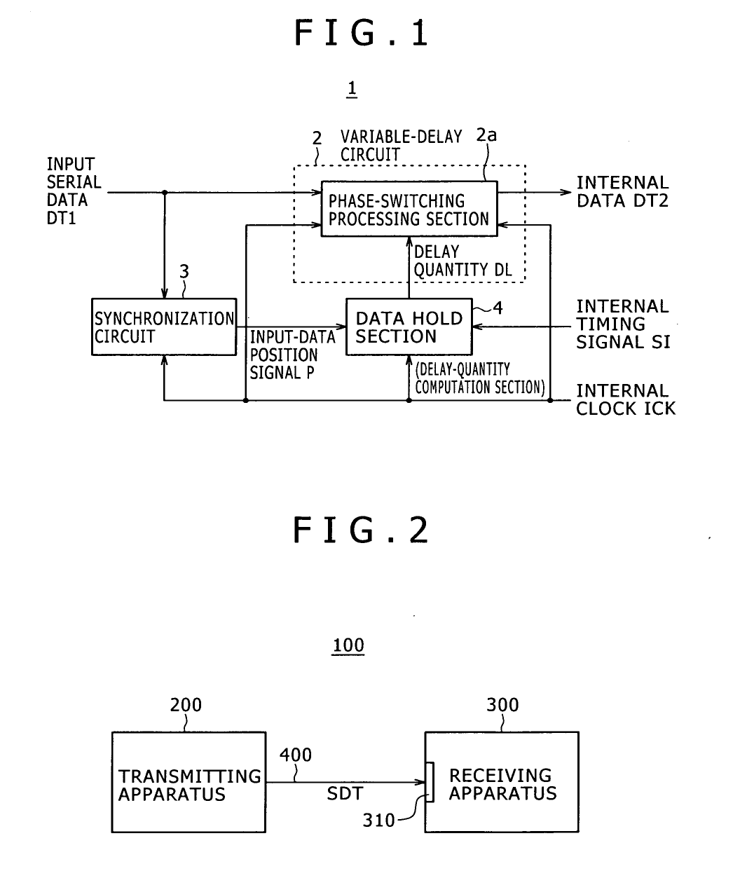

### DETAILED DESCRIPTION OF THE PREFERRED EMBODIMENT

An embodiment of the present disclosure is explained below by referring to the diagrams. It is to be noted that the embodiment is described in the following order:
1. Basic Configuration of a Communication System
2. Configuration of a Phase Adjustment Circuit
3. Principle to Detect Information on the Phase of a Clock by Making Use of Information on the Position of a Comma Pattern

### 1. Basic Configuration of a Communication System

FIG. 2 is a block diagram showing the basic configuration of a communication system 100 according to an embodiment of the present disclosure.

As shown in the figure, the communication system 100 is configured to include a transmitting apparatus 200, a receiving apparatus 300 and a data transmission line 400 connected between the transmitting apparatus 200 and the receiving apparatus 300.

The transmitting apparatus 200 transmits serial data SDT synchronized with a plurality of phases to the receiving apparatus 300 through the data transmission line 400.

The transmitting apparatus 200 inserts comma patterns each used as a synchronization pattern at predetermined positions in the serial data SDT.

The receiving apparatus 300 functions as a serial communication receiver for receiving the serial data SDT propagating through the data transmission line 400.

The receiving apparatus 300 has a phase adjustment circuit 310 including a serial-to-parallel conversion circuit for converting the serial data SDT into parallel data.

After carrying out processing to convert the serial data SDT including a comma pattern used as a synchronization pattern into the parallel data, on the basis of information on the position of the comma pattern in the parallel data, the phase adjustment circuit 310 adjusts the phases of the data and a clock.

In accordance with the phase adjustment carried out by the phase adjustment circuit 310, the position of a comma pattern used as a synchronization pattern in the input serial data SDT is used. Thus, it is possible to adjust skews between a plurality of channels with their input serial data having the same comma-pattern position.

The phase adjustment circuit 310 adjusts the phases by selecting a clock with the optimum phase from clocks prepared to have a number of phases.

The following description explains the concrete configuration of the phase adjustment circuit 310 employed in the receiving apparatus 300 having a configuration serving as a characteristic of the embodiment and explains functions carried out by the phase adjustment circuit 310.

As an example, a reference data transition gap of 4 bits is taken in the following description.

### 2. Configuration of a Phase Adjustment Circuit

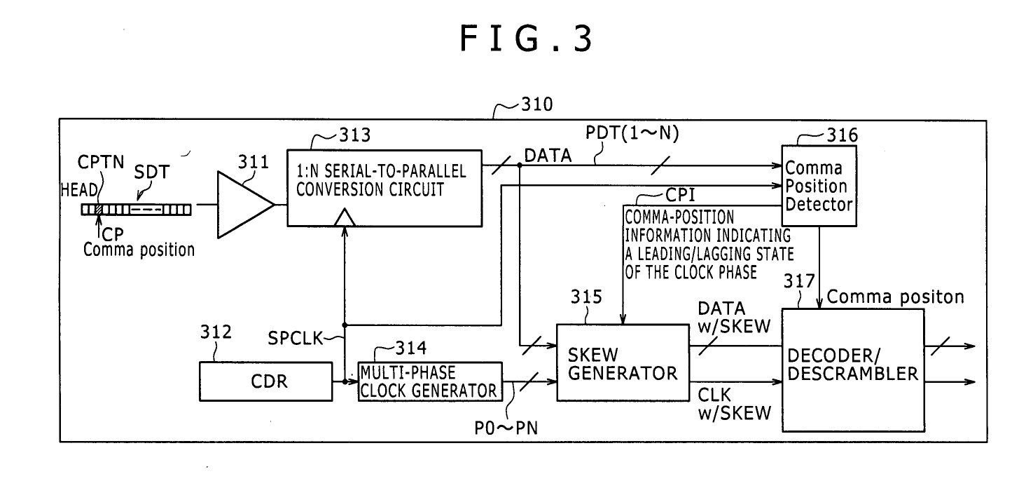

FIG. 3 is a block diagram showing the configuration of the phase adjustment circuit 310 employed in the receiving apparatus 300 included in the communication system 100 in accordance with the embodiment of the present disclosure.

As shown in FIG. 3, the phase adjustment circuit 310 employs an input buffer 311, a CDR (clock/data recovery) circuit 312 and a serial-to-parallel conversion circuit 313. In addition, the phase adjustment circuit 310 also includes a multi-phase clock generator 314, a skew generator 315, a comma-position detector 316 and a decoder/descrambler 317.

The skew generator 315 functions as an adjustment section for adjusting the phases of the parallel data and a clock.

The input buffer 311 receives the serial data SDT propagating through the data transmission line 400 and supplies the serial data SDT to the serial-to-parallel conversion circuit 313.

The input serial data SDT includes a comma pattern CPTN inserted into a predetermined position to serve as a synchronization pattern. In the case of the serial data SDT of the typical example shown in FIG. 3, the predetermined position is the third field from the head of the serial data SDT.

The CDR circuit 312 extracts a clock with a serial data input used as a trigger and makes use of the clock to latch a data signal of a periodically inserted signal. As described earlier, the serial data input has propagated through the data transmission line 400 as the serial data including the periodically inserted signal.

The CDR circuit 312 supplies the extracted clock to the serial-to-parallel conversion circuit 313, the multi-phase clock generator 314 and the comma-position detector 316 as a conversion clock SPCLK.

The serial-to-parallel conversion circuit 313 carries out 1:N data conversion to convert the input serial data SDT into parallel data having N bits synchronously with the conversion clock SPCLK.

The serial-to-parallel conversion circuit 313 supplies the parallel data PDT (1 to N) obtained as a result of the 1:N data conversion to the skew generator 315 and the comma-position detector 316.

Basically, the multi-phase clock generator 314 generates multi-phase clocks P(0) to P(N−1) having phases different from each other and a frequency lower than that of the conversion clock SPCLK in synchronization with the conversion clock SPCLK generated by the CDR circuit 312.

The multi-phase clock generator 314 outputs the multi-phase clocks P(0) to P(N−1) to the skew generator 315.

On the basis of comma-position information CPI received from the comma-position detector 316, the skew generator 315 selects a clock having the optimum skew quantity from the multi-phase clocks P(0) to P(N−1).

The skew generator 315 synchronizes the parallel data PDT with the selected clock and hand off the data PDT to the selected clock, and outputs the parallel data PDT along with the clock to the decoder/descrambler 317 provided at a later stage.

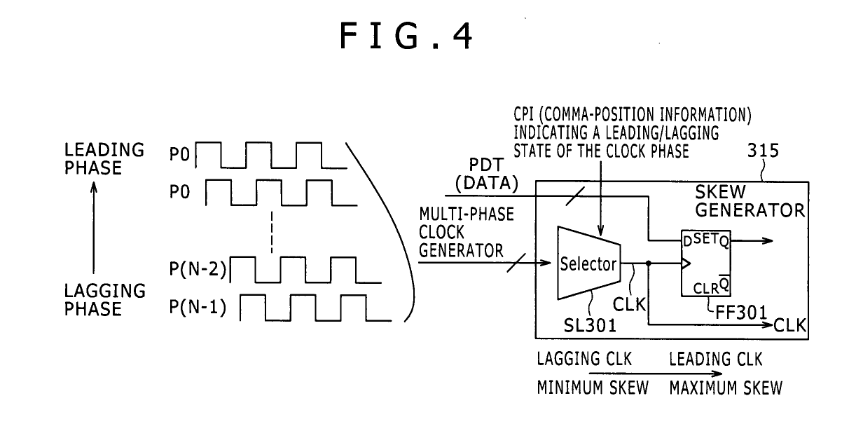

FIG. 4 is a block diagram showing a typical configuration of the skew generator 315 employed in the phase adjustment circuit 310 according to the embodiment of the present disclosure.

As shown in. FIG. 4, the skew generator 315 employs a selector SL301 and a D flip-flop FF301. On the basis of the comma-position information CPI received from the comma-position detector 316, the selector SL301 selects a clock CLK having the optimum skew quantity from the multi-phase clocks P(0) to P(N−1) generated by the multi-phase clock generator 314.

The selector SL301 supplies the selected clock CLK to the clock input terminal of the D flip-flop FF301 and the decoder/descrambler 317 provided at a later stage.

The data input terminal D of the D flip-flop FF301 receives the parallel data PDT generated by the serial-to-parallel conversion circuit 313 and the D flip-flop FF301 latches the parallel data PDT synchronously with the clock CLK selected by the selector SL301. Then, the D flip-flop FF301 supplies the latched data to the decoder/descrambler 317 provided at a later stage from the data output terminal Q of the D flip-flop FF301.

Receiving the conversion clock SPCLK from the CDR circuit 312, the comma-position detector 316 detects the position of a comma pattern in the parallel data PDT in order to generate comma-position information CPI indicating a data portion at which the comma pattern is located.

The comma-position detector 316 feeds the comma-position information CPI generated thereby back to the skew generator 315 and supplies the comma-position information CPI to the decoder/descrambler 317.

It is to be noted that the comma-position information CPI is information showing the lagging or leading state of the phase of the clock.

In synchronization with the clock CLK selected as a clock having the optimum skew quantity, the decoder/descrambler 317 carries out decode and descramble processing on the parallel data PDT handed off to this clock CLK.

The concrete phase adjustment carried out by the phase adjustment circuit 310 having the configuration explained above is described by associating the phase adjustment with typical configurations of the skew generator 315, the serial-to-parallel conversion circuit 313 and the multi-phase clock generator 314 as follows.

First of all, an outline of an operation carried out by the phase adjustment circuit 310 is explained as follows.

In the phase adjustment circuit 310, the serial-to-parallel conversion circuit 313 converts the serial data SDT into the parallel data PDT.

Later on, the comma-position detector 316 detects the position of a comma pattern in the parallel data PDT and feeds comma-position information CPI showing the position of the comma pattern back to the skew generator 315. In the following description, the comma-position information CPI is also referred to as CLK lagging/leading information in some cases.

On the basis of the comma-position information CPI, the skew generator 315 selects a clock CLK having the optimum skew quantity from the multi-phase clocks P(0) to P(N−1) and synchronizes the parallel data PDT with the selected clock CLK. Then, the skew generator 315 hands off the parallel data PDT to the selected clock CLK.

Subsequently, the skew generator 315 supplies the parallel data PDT and the selected clock CLK to the decoder/descrambler 317 provided at a later stage 3. Principle to Detect Information on the Phase of a Clock by Making Use of Information on the Position of a Comma Pattern

Next, the following description explains a principle to detect information on the phase of a clock CLK by making use of information on the position of a comma pattern serving as a synchronization pattern.

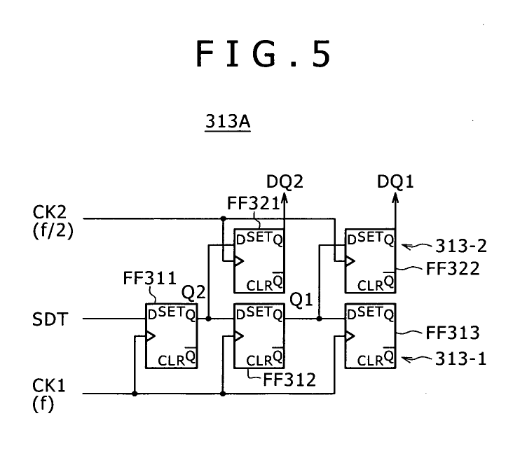

In order to make the explanation simple, FIG. 5 showing a 1:2 serial-to-parallel conversion circuit 313A is referred to.

FIG. 5 is an explanatory diagram referred to in the following description of a principle to detect information on the phase of a clock CLK by making use of information on the position of a comma pattern serving as a synchronization pattern as a diagram showing the configuration of a 1:2 serial-to-parallel conversion circuit 313A.

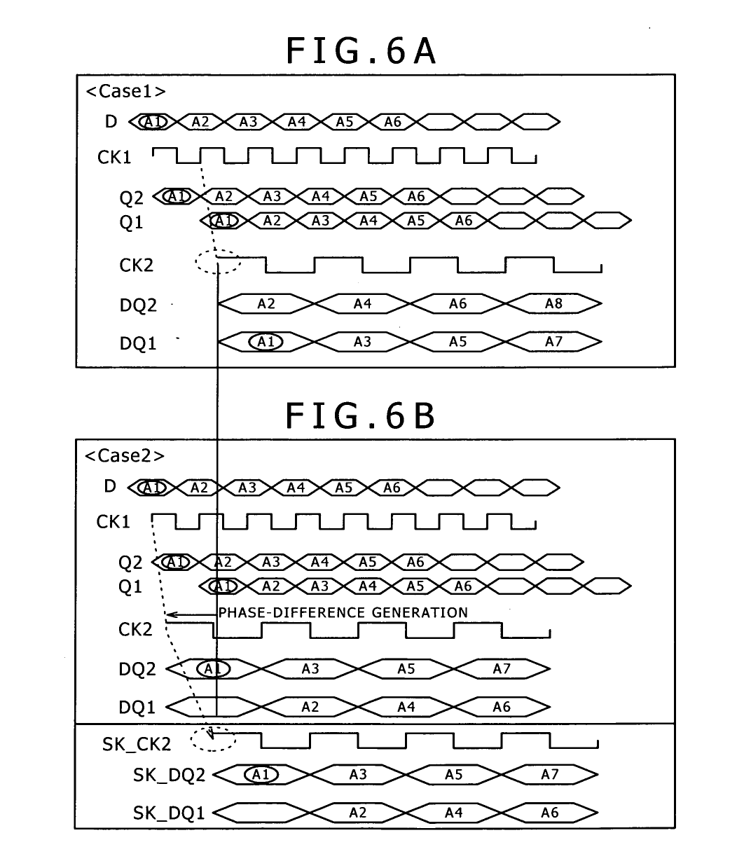

FIGS. 6A and 6B are explanatory diagrams referred to in the following description of the phase of a second clock for confirming data output by the 1:2 serial-to-parallel conversion circuit 313A shown in FIG. 5.

As shown in FIG. 5, the 1:2 serial-to-parallel conversion circuit 313A is configured to employ D flip-flops FF311 to FF313 used for shifting data as well as D flip-flops FF321 and FF322 used for latching data and outputting parallel data.

The D flip-flops FF311 to FF313 used for shifting data function as a plurality of latches for latching input serial data SDT synchronously with a first clock CK1. In this way, the D flip-flops FF311 to FF313 used for shifting data form a first latch section 313-1.

On the other hand, the D flip-flops FF321 and FF322 used for latching data and outputting parallel data function as a plurality of latches for latching the data latched in the first latch section 313-1 and outputting the data as N pieces of parallel data PDT in synchronization with the second clock CLK2. In this way, the D flip-flops FF321 and FF322 used for latching data and outputting parallel data form a second latch section 313-2.

The clock input terminal of each of the D flip-flops FF311 to FF313 receives the first clock CK1 serving as a shift clock having a frequency f. The shift clock CK1 is a clock synchronous with the conversion clock SPCLK generated by the CDR circuit 312. In some cases, the shift clock CK1 may be the conversion clock SPCLK.

The data input terminal D of the D flip-flop FF311 is connected to a line for supplying the serial data SDT whereas the data output terminal Q of the D flip-flop FF311 is connected to the data input terminal D of the D flip-flop FF312 and the data input terminal D of the D flip-flop FF321.

The data output terminal Q of the D flip-flop FF312 is connected to the data input terminal D of the D flip-flop FF313 and the data input terminal D of the D flip-flop FF322.

The clock input terminal of each of the D flip-flops FF321 to FF322 receives a second clock CK2 having a frequency of f/2. The second clock CK2 is generated by dividing the first clock CK1 serving as a shift clock.

The 1:2 serial-to-parallel conversion circuit 313A shifts the input serial data SDT synchronously with the first clock CK1. Then, synchronously with the second clock CK2 generated by dividing the frequency f of the first clock CK1 by 2, the 1:2 serial-to-parallel conversion circuit 313A confirms the parallel output data DQ2 and the parallel output data DQ1 in 1:2 serial-to-parallel conversion.

However, since the second clock CK2 is generated by dividing the frequency f of the first clock CK1 by 2, the phase of the second clock CK2 can be a phase of a first case referred to as case 1 shown in FIG. 6A or a phase of a second case referred to as case 2 shown in FIG. 6B.

It is not possible to deterministically predict whether the phase of the second clock CK2 is the phase of the first case or the phase of the second case because the phase of the second clock CK2 is determined by initial contents of a frequency-divider counter.

For the first case referred to as case 1 shown in FIG. 6A, let reference notation A1 denote a position at which a comma pattern exists or denote the comma pattern itself. In this case, it is possible to determine whether the phase of the second clock CK2 is leading or lagging by determining whether the comma pattern A1 is output from the parallel output data DQ1 obtained as a result of the serial-to-parallel conversion processing or the parallel output data DQ2 also obtained as a result of the serial-to-parallel conversion processing.

For the second case referred to as case 2 shown in FIG. 6B, on the other hand, the phase of the second clock CK2 is leading ahead of the first case referred to as case 1 shown in FIG. 6A. Thus, the comma pattern A1 is not shifted till the D flip-flop FF321 for outputting the parallel output data DQ1. As a result, the comma pattern A1 is output as the parallel output data DQ2 of the D flip-flop FF321.

Therefore, in the typical case described above, from the fact that the position of a comma pattern has been obtained from the parallel output data DQ2, the comma-position detector 316 determines a leading clock CLK and shifts the phase of the second clock CK2 in the lagging direction.

That is to say, a clock on the lagging-phase side is selected from the two prepared clocks having phases different from each other.

The above description has taken the 1:2 serial-to-parallel conversion as a typical case. However, the above description also holds true for 1:N serial-to-parallel conversion as well.

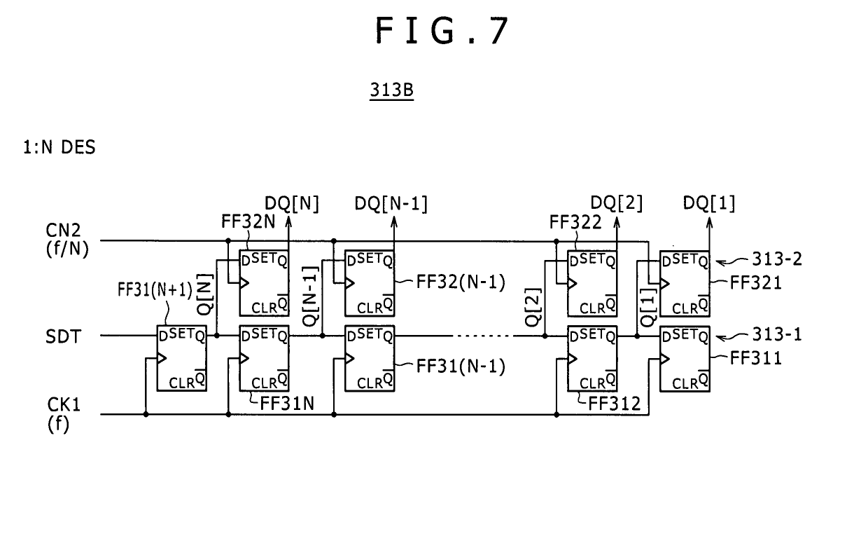

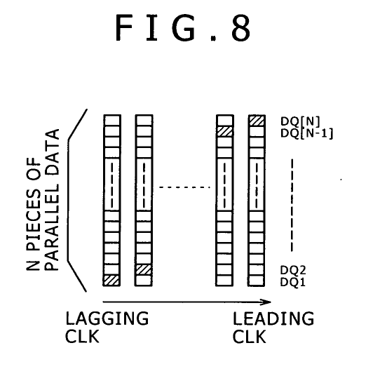

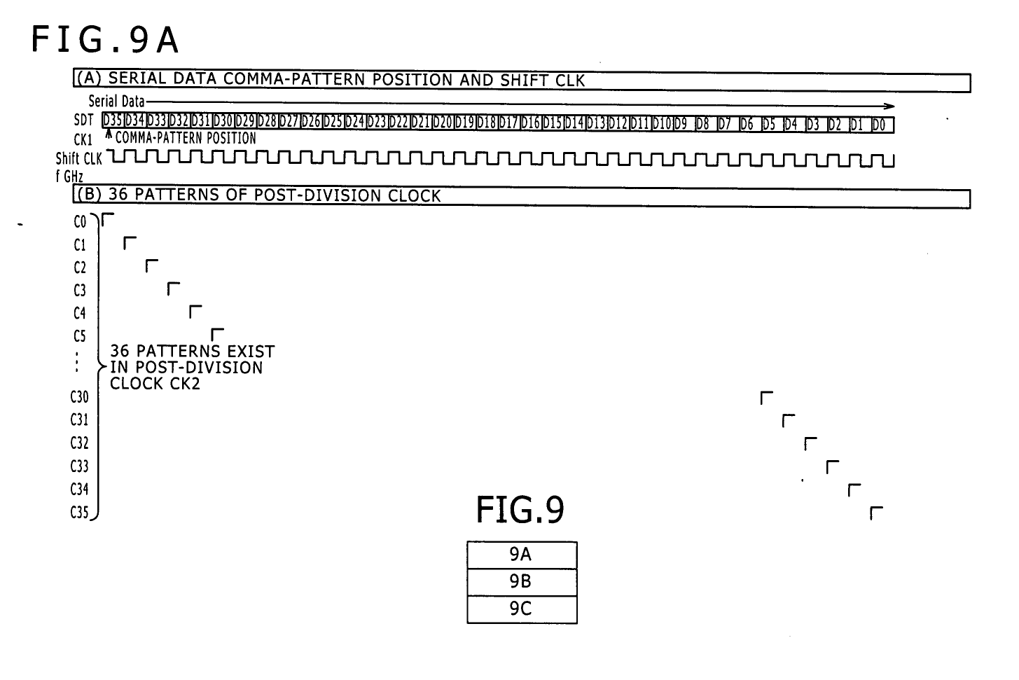

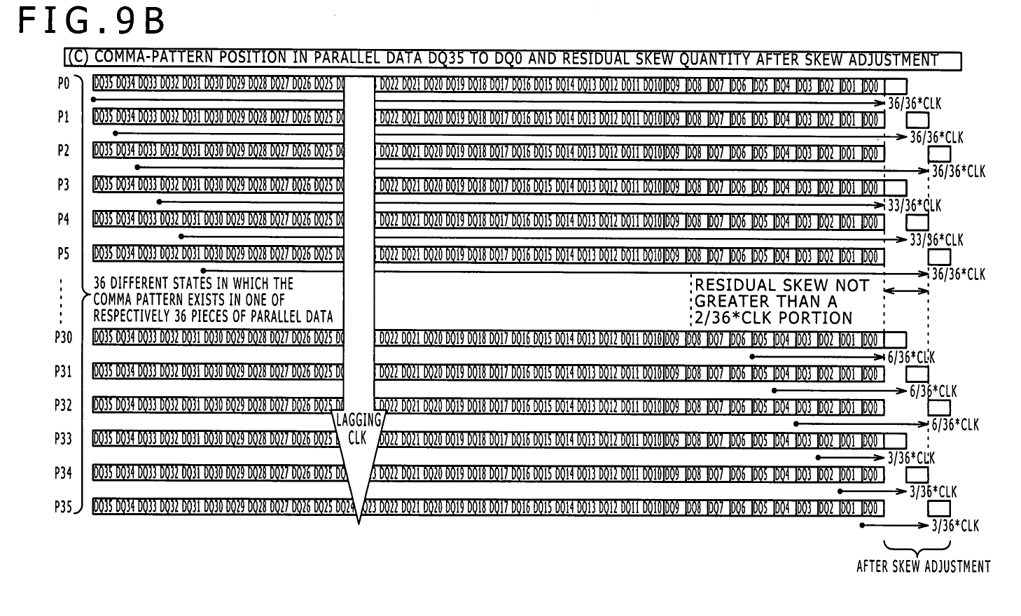

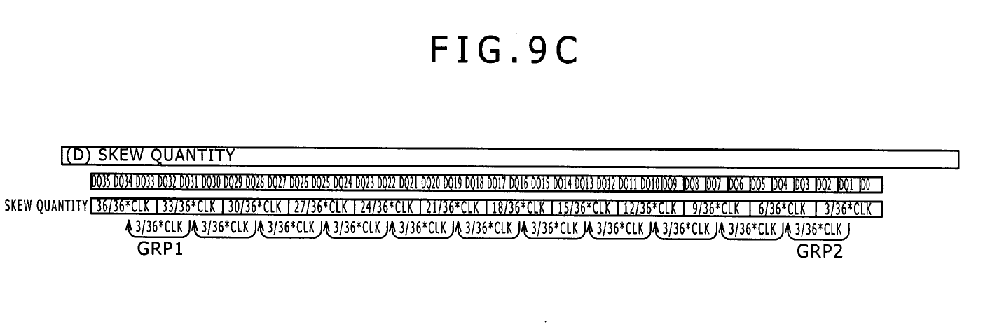

FIG. 7 is a circuit diagram showing the configuration of a 1:N serial-to-parallel conversion circuit 313B whereas FIG. 8 is a diagram showing leading and lagging relations between the phases of N pieces of parallel data output by the 1:N serial-to-parallel conversion circuit 313B shown in FIG. 7 and the phase of a clock.

As shown in FIG. 7, the 1:N serial-to-parallel conversion circuit 313B is configured to employ D flip-flops FF311 to FF31(N+1) used for shifting data and D flip-flops FF321 and FF32N used for latching and outputting parallel data.

The D flip-flops FF311 to FF31(N+1) used for shifting data function as a plurality of latches for latching input serial data SDT synchronously with a first clock CK1. In this way, the D flip-flops FF311 to FF31(N+1) used for shifting data form a first latch section 313-1.

On the other hand, the D flip-flops FF321 to FF32N used for latching data and outputting parallel data function as a plurality of latches for, in synchronization with the second clock CK2, latching the data latched in the first latch section 313-1 and outputting the data latched in the D flip-flops FF321 to FF32N as respectively N pieces of parallel data PDT. That is to say, the N pieces of parallel data PDT are parallel output data DQ1 to parallel output data DQN which are to be described later. In this way, the D flip-flops FF321 to FF32N used for latching data and outputting parallel data form a second latch section 313-2 for outputting the parallel data PDT.

The connections of the 1:N serial-to-parallel conversion circuit 313B shown in FIG. 7 are basically identical with those of the 1:2 serial-to-parallel conversion circuit 313A shown in FIG. 5. Thus, detailed explanation of the 1:N serial-to-parallel conversion circuit 313B is omitted.

In addition, a data position represented by a hatched portion in each of the N pieces of parallel data shown in FIG. 8 is a comma-pattern position at which a comma pattern is located.

In the case of the 1:N serial-to-parallel conversion circuit 313B, the second clock CK2 has N different phases. Thus, there are N different comma-pattern positions at each of which a comma pattern is located. For this reason, an N-phase clock CK2 is generated. Therefore, the skew generator 315 selects the optimum clock CLK in accordance with the comma-position information CPI received from the comma-position detector 316 among multi-phase clocks P(0) to P(N−1).

If the most lagging comma-pattern position has been detected for example, the skew generator 315 selects a clock CLK with the most leading phase as a clock for minimizing the skew quantity. If the most leading comma-pattern position has been detected, on the other hand, the skew generator 315 selects a clock CLK with the most lagging phase as a clock for maximizing the skew quantity.

The comma-position information CPI received by the skew generator 315 is parallel data having N bits. Among the N bits of simplest typical comma-position information CPI, only the detection bit representing the detected comma-pattern position is set at 1. The other bits are set at 0.

It is needless to say that implementations of the 1:N serial-to-parallel conversion circuit 313B are by no means limited to the configuration shown in FIG. 7. For example, the ratio of 1:N can be divided into several stages.

As described so far, the embodiment selects a clock with the optimum phase from the multi-phase clocks P(0) to P(N−1) having phases different from each other as a clock agreeing with the comma-pattern position in the serial data SDT in order to carry out skew adjustment.

Depending on the allowable skew of a system provided at a later stage, however, the number of multi-phase clocks P having phases different from each other does not have to be N as described before. For example, the number of multi-phase clocks P can be N/2, N/3 or another value. That is to say, the scale of the circuit can be reduced in accordance with the specifications.

The following description shows typical timings for 12-phase clocks obtained by setting N at 36 for the 1:N serial-to-parallel conversion circuit 313B shown in FIG. 7.

(A) to (D) of FIG. 9 are diagrams showing typical timings for a case in which 12 clocks having phases different from each other are used in the 1:N serial-to-parallel conversion circuit 313B shown in FIG. 7 where N=36.

The comma-pattern position in the serial data SDT is fixed. However, the second clock CK2 for latching data in the serial-to-parallel conversion circuit 313 is generated by dividing the frequency of the first clock CK1 so that 36 different comma patterns C0 to C35 exist as shown in (B) of FIG. 9.

Thus, as shown in (C) of FIG. 9, there are 36 different timings with which data is latched. Therefore, there are 36 different states in which the comma pattern exists in one of respectively the 36 pieces of parallel data DQ36 to DQ1.

The later the second clock CK2 for latching data, the larger the shift quantity by which the data is shifted. Thus, for a late second clock CK2, the comma pattern exists in parallel data DQ* where suffix * denotes a small integer.

In order to solve this problem, as shown in (D) of FIG. 9, the 36 pieces of parallel data DQ36 to DQ1 are grouped into 12 groups GRP1 to GRP12 each including three pieces of parallel data DQ. Then, a skew quantity is assigned to each of the 12 groups GRP1 to GRP12. Thus, there are 12 different skew quantities.

Timings after the skew adjustment are shown in the later part of (C) of FIG. 9. In the figure, the later part of (C) of FIG. 9 is denoted by the phrase ‘After skew adjustment.’ The quantity of a residual skew is not greater than a quantity represented by 2/36*CK2= 1/18*CK2.

If this skew quantity is sufficiently smaller than the allowable specification quantity of a system provided at a later stage, the 12-phase clock with a phase count equal to ⅓ of the phase count of 36 for the 36-phase clock used in the case of this typical example can be used in place of the 36-phase clock.

Next, a typical configuration of the multi-phase clock generator 314 is explained.

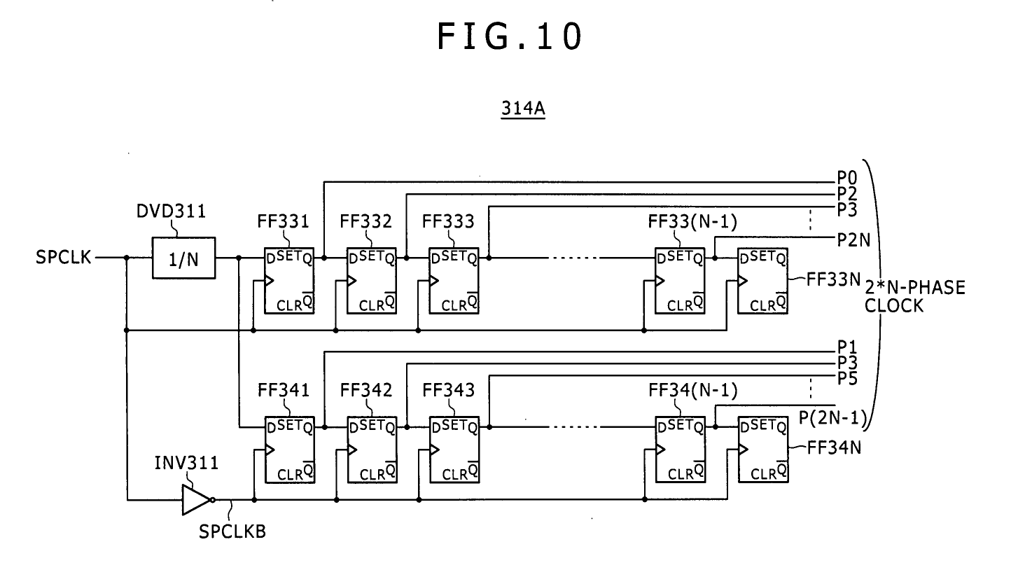

FIG. 10 is a circuit diagram showing a typical configuration of a multi-phase clock generator 314A according to the embodiment.

As shown in FIG. 10, the multi-phase clock generator 314 is configured to employ normal-phase-side D flip-flops FF331 to FF33N, reversed-phase-side D flip-flops FF341 to FF34N, a one-Nth frequency divider DVD311 and an inverter INV311.

The one-Nth frequency divider DVD311 is a section for dividing the frequency of the conversion clock SPCLK, which is generated by the CDR circuit 312, by N.

The data input terminals D of the D flip-flops FF331 to FF33N and the data output terminals Q of the D flip-flops FF331 to FF33N are interconnected to form a cascade connection with respect to the output terminal of the one-Nth frequency divider DVD311. The clock input terminal of each of the D flip-flops FF331 to FF33N receives the conversion clock SPCLK having the normal phase.

By the same token, the data input terminals D of the D flip-flops FF341 to FF34N and the data output terminals Q of the D flip-flops FF341 to FF34N are interconnected to form a cascade connection with respect to the output terminal of the one-Nth frequency divider DVD311. However, the clock input terminal of each of the D flip-flops FF341 to FF34N receives the inverted conversion clock SPCLK, that is to say, an conversion clock SPCLKB through the inverter INV311.

As described above, the multi-phase clock generator 314A shown in FIG. 10 has a configuration in which the phase of a clock having a frequency equal to 1/N of the frequency of the pre-division conversion clock SPCLK is shifted by making use of the normal and reversed phases of the pre-division conversion clock SPCLK. The pre-division conversion clock SPCLK is the conversion clock SPCLK not subjected yet to the frequency division.

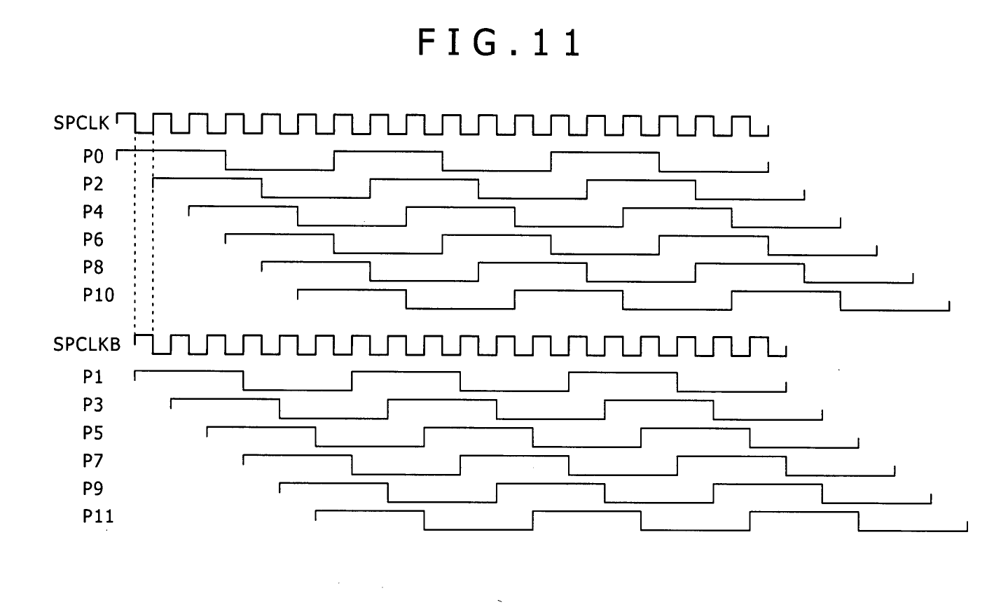

FIG. 11 is a diagram showing relation of timings for N=6 in the multi-phase clock generator 314A shown in FIG. 10.

In this typical example, the D flip-flops FF331 to FF336 generate multi-phase clocks P0, P2, P4, P6, P8 and P10. On the other hand, the D flip-flops FF341 to FF346 generate multi-phase clocks P1, P3, P5, P7, P9 and P11. As a result, the multi-phase clock generator 314A generates 12-phase clocks P0 to P11.

It is to be noted that, in the typical example described above, a shift register is used in the method for generating a multi-phase clock. However, techniques for generating a multi-phase clock are by no means limited to this method.

As described above, in accordance with this embodiment, if the positions of the comma patterns in the input serial data SDT have the same timing, the quantities of skews between a plurality of channels can be adjusted. As a matter of fact, it is possible to adjust the quantities of skews not only between a plurality of channels included in the same IC, but also between a plurality of channels spread over different ICs.

In addition, in the case of a plurality of channels included in the same IC, in accordance with this embodiment, the quantities of skews between the channels can be decreased. It is thus possible to implement the reduction of the quantities of skews by making use of a circuit (a circuit for setting re-timings by making use of a reversed-phase clock) allowing a clock of any channel to be used in order to very easily establish synchronization with another channel.

That is to say, in accordance with this embodiment, it is possible to provide a phase adjustment circuit which can establish synchronization among a plurality of channels while preventing the circuit configuration from increasing complexity and preventing the power consumption from increasing, and can be applied to high-speed serial communications.

It is to be noted that implementations of the present disclosure are by no means limited to the embodiment described above. That is to say, the embodiment can be changed to a variety of modified versions within a range not deviating from essentials of the present disclosure.

The present disclosure contains subject matter related to that disclosed in Japanese Priority Patent Application JP 2010-206741 filed in the Japan Patent Office on Sep. 15, 2010, the entire content of which is hereby incorporated by reference.

What is claimed is:

1. A phase adjustment circuit comprising:
a serial-to-parallel conversion section configured to convert serial data including a synchronization pattern inserted into a predetermined position into parallel data in response to a clock;
a synchronization-pattern-position detection section configured to detect the position of said synchronization pattern in said parallel data generated by said serial-to-parallel conversion section; and
an adjustment section configured to adjust the phases of said parallel data and said clock to conform to a position detected by said synchronization-pattern-position detection section as said position of said synchronization pattern in accordance with information on said position of said synchronization pattern.

2. The phase adjustment circuit according to claim 1, further comprising
a multi-phase clock generator configured to generate a plurality of clocks having different phases on the basis of a clock supplied to said serial-to-parallel conversion section, wherein
said adjustment section
selects a clock having an optimum phase conforming to a position detected by said synchronization-pattern-position detection section as the position of said synchronization pattern in accordance with information on said position of said synchronization pattern from said clocks having different phases, and
outputs data obtained by synchronizing said parallel data with said selected clock along with said selected clock.

3. The phase adjustment circuit according to claim 2, wherein:
said serial-to-parallel conversion section includes
a first latch section having a plurality of latches for latching and shifting said serial data received synchronously with a first clock, and
a second latch section configured to latch data latched in said latches of said first latch section and outputting said data as N pieces of parallel data synchronously with a second clock generated by dividing the frequency of said first clock; and
said synchronization-pattern-position detection section
detects whether any of said N pieces of parallel data output by said second latch section includes said synchronization pattern,
determines whether the phase of said second clock is leading or lagging in accordance with a result of detection on said parallel data including said synchronization pattern, and
outputs synchronization pattern position information to said adjustment section to serve as information showing whether the phase of said second clock is leading or lagging.

4. The phase adjustment circuit according to claim 3, wherein
said adjustment section selects,
if said synchronization pattern position information indicates that the phase of said second clock is leading by a predetermined leading quantity, a clock lagging by a lagging quantity corresponding to said predetermined leading quantity, and
if said synchronization pattern position information indicates that the phase of said second clock is lagging by a predetermined lagging quantity, a clock leading by a leading quantity corresponding to said predetermined lagging quantity.

5. The phase adjustment circuit according to claim 3, wherein:
said N pieces of parallel data are delimited to form a plurality of successive groups each including some consecutive ones of said N pieces of parallel data by sustaining the continuous succession of said N pieces of parallel data as it is; and
said multi-phase clock generator generates a plurality of clocks each assigned to a specific one of said groups to serve as a clock having a phase unique to said specific group.

6. A receiving apparatus comprising
a phase adjustment circuit configured to carry out functions to
receive serial data propagating through a data transmission line and including a synchronization pattern inserted into a predetermined position,
convert said input serial data into parallel data, and
adjust the phases of said parallel data and a clock in accordance with information on a position acquired from said parallel data as the position of said synchronization pattern,
wherein, in order to carry out said functions, said phase adjustment circuit includes
a serial-to-parallel conversion section configured to convert said serial data including a synchronization pattern inserted into a predetermined position into said parallel data in response to said clock,
a synchronization-pattern-position detection section configured to detect the position of said synchronization pattern in said parallel data generated by said serial-to-parallel conversion section, and
an adjustment section configured to adjust the phases of said parallel data and said clock to conform to a position detected by said synchronization-pattern-position detection section as said position of said synchronization pattern in accordance with information on said position of said synchronization pattern.

7. The receiving apparatus according to claim 6, wherein:
said phase adjustment circuit further includes
a multi-phase clock generator configured to generate a plurality of clocks having different phases on the basis of a clock supplied to said serial-to-parallel conversion section; and
said adjustment section
selects a clock having an optimum phase conforming to a position detected by said synchronization-pattern-position detection section as the position of said synchronization pattern in accordance with information on said position of said synchronization pattern from said clocks having different phases, and
outputs data obtained by synchronizing said parallel data with said selected clock along with said selected clock.

8. The receiving apparatus according to claim 7, wherein:
said serial-to-parallel conversion section includes
a first latch section having a plurality of latches for latching and shifting said serial data received synchronously with a first clock, and
a second latch section configured to latch data latched in said latches of said first latch section and output said data as N pieces of parallel data synchronously with a second clock generated by dividing the frequency of said first clock; and
said synchronization-pattern-position detection section
detects whether any of said N pieces of parallel data output by said second latch section includes said synchronization pattern,
determines whether the phase of said second clock is leading or lagging in accordance with a result of said determination on said parallel data including said synchronization pattern, and
outputs synchronization pattern position information to said adjustment section to serve as information showing whether the phase of said second clock is leading or lagging.

9. The receiving apparatus according to claim 8, wherein
said adjustment section selects
if said synchronization pattern position information indicates that the phase of said second clock is leading by a predetermined leading quantity, a clock lagging by a lagging quantity corresponding to said predetermined leading quantity, and
if said synchronization pattern position information indicates that the phase of said second clock is lagging by a predetermined lagging quantity, a clock leading by a leading quantity corresponding to said predetermined lagging quantity.

10. The receiving apparatus according to claim 8, wherein:
said phase adjustment circuit delimits said N pieces of parallel data to form a plurality of successive groups each including some consecutive ones of said N pieces of parallel data; and
said multi-phase clock generator generates a plurality of clocks each assigned to a specific one of said groups to serve as a clock having a phase unique to said specific group.

11. A communication system comprising:
a transmitting apparatus configured to transmit serial data including a synchronization pattern inserted into a predetermined position through a data transmission line; and
a receiving apparatus configured to receive said serial data propagating through said data transmission line and including a synchronization pattern inserted into a predetermined position, wherein
said receiving apparatus includes
a phase adjustment circuit for
converting said serial data received thereby into parallel data, and
adjusting the phases of said parallel data and a clock in accordance with information on a position acquired from said parallel data as the position of said synchronization pattern,
said phase adjustment circuit including
a serial-to-parallel conversion section configured to convert said serial data including a synchronization pattern inserted into a predetermined position into said parallel data in response to said clock,
a synchronization-pattern-position detection section configured to detect said position of said synchronization pattern in said parallel data generated by said serial-to-parallel conversion section, and
an adjustment section configured to adjust said phases of said parallel data and said clock to conform to a position detected by said synchronization-pattern-position detection section as said position of said synchronization pattern in accordance with information on said position of said synchronization pattern.
